(19) United States
(12) Patent Application Publication
(10) Pub. No.: US 2025/0390963 A1
(43) Pub. Date: Dec. 25, 2025

(54) SYSTEMS AND METHODS FOR PROVIDING AND TRACKING GRATITUDE NOTICES

(71) Applicants: Sujit Mahbubani Ramchand, Rego Park, NY (US); Sachin Ramesh Raval, Hoboken, NJ (US)

(72) Inventors: Sujit Mahbubani Ramchand, Rego Park, NY (US); Sachin Ramesh Raval, Hoboken, NJ (US)

(21) Appl. No.: 19/246,559

(22) Filed: Jun. 23, 2025

Related U.S. Application Data
(60) Provisional application No. 63/663,475, filed on Jun. 24, 2024.

(51) Int. Cl. G06Q 50/00; H04L 51/04; H04L 51/18

(52) U.S. Cl. CPC G06Q 50/01; H04L 51/04; H04L 51/18

(57) ABSTRACT

A computer system generates a gratitude notification that includes an appreciation of gratitude from a sender for a service or donation from a recipient. The computer system obtains a first permission level for the gratitude notification from the sender and a second permission level for the gratitude notification from the recipient. The computer system reconciles the first permission level and the second permission level to determine an associated permission level for the gratitude notification. When the associated permission level for the gratitude notification permits, the computer system posts the gratitude notification to at least one social media account of the recipient and/or the sender. The computer system maintains a notification database that is publicly accessible to the extent permitted by the permission levels for the gratitude notifications.

### CROSS REFERENCE TO RELATED APPLICATIONS

This application is a U.S. non-provisional patent application claiming priority under 35 U.S.C. § 119 (e) to U.S. provisional patent application No. 63/663,475, filed Jun. 24, 2024, entitled, “SYSTEMS AND METHODS FOR PROVIDING AND TRACKING GRATITUDE NOTICES,” which is hereby expressly incorporated by reference as if fully set forth herein.

### COPYRIGHT NOTICE

A portion of the disclosure of this patent document contains material which is or may be subject to copyright protection. The copyright owner has no objection to the facsimile reproduction by anyone of the patent document or the patent disclosure, as it appears in the Patent and Trademark Office patent file or records but otherwise reserves all copyrights whatsoever.

### FIELD

Embodiments of the present application generally relate to a computer network and application for generating notifications of gratitude for acts of kindness on one or more social media websites and for tracking such gratitude notifications for acts of kindness in a searchable database.

### BACKGROUND OF THE INVENTION

We live in a world where people like to share and publicize many aspects of their personal and professional lives and seek affirmation online. People share on social media information about the food that they are eating, the restaurants where they dine, the company that they keep, their vacations, the clothes they wear, and the parties they attend.

Daily, millions of people around the world perform acts of help and kindness. For example, a college student mows the lawn of a neighbor, a professional provides free professional services for a family member or friend, or a churchgoer may partake in a fundraising campaign at their local church, Many individuals make donations to various charities and alumni associations, help neighbors, and volunteer. Gratitude for such acts of kindness is often expressed privately, if at all, and done so over a phone call or by text or by email, and the matter ends there privately. There is currently no easy way to share appreciation for such acts of kindness on social media. There are currently no social media websites that provide a public documentation of an act of kindness and no databases or compilations of the acts of kindness of an individual or company.

Thus, there is a need for a public computerized system and method for easily providing public gratitude for acts of kindness and for tracking and compiling acts of kindness in a searchable database.

### BRIEF SUMMARY OF THE INVENTION

In one aspect, a computer system comprises at least one memory device and at least one processing circuit, wherein the processing circuit is operatively coupled to the at least one memory device and wherein the at least one memory device stores instructions that, when executed by the at least one processing circuit, causes the computer system to generate a gratitude notification using input data from a user device of a sender, wherein the gratitude notification includes a plurality of data fields, wherein the plurality of data fields includes at least the sender, a recipient, and donation or service data. The computer system further obtains a first permission level for the gratitude notification and/or one or more of the plurality of data fields from the user device of the sender and obtains a second permission level for the gratitude notification and/or the one or more of the plurality of data fields from the recipient. The computer system reconciles the first permission level and the second permission level to determine an associated permission level for the gratitude notification and determines the associated permission level for the gratitude notification permits posting the gratitude notification to at least one social media account of a social media system of the recipient. The computer system communicates with the social media system to post the gratitude notification to the at least one social media account of the social media system of the recipient.

In another aspect, a method of a computer system for generating a gratitude notification, comprises generating, by at least one processing unit of the computer system, the gratitude notification using input data from a user device of a sender, wherein the gratitude notification includes a plurality of data fields, wherein the plurality of data fields includes at least the sender, a recipient, and donation or service data. The method further comprises obtaining, by the at least one processing unit of the computer system, a first permission level for the gratitude notification and/or one or more of the plurality of data fields from the user device of the sender and obtaining, by the at least one processing unit of the computer system, a second permission level for the gratitude notification and/or the one or more of the plurality of data fields from the recipient. The method further comprises reconciling, by the at least one processing unit of the computer system, the first permission level and the second permission level to determine an associated permission level for the gratitude notification and determining, by the at least one processing unit of the computer system, the associated permission level for the gratitude notification permits posting the gratitude notification to at least one social media account of a social media system of the recipient. The method further comprises communicating, by the at least one processing unit and a transceiver of the computer system, with the social media system to post the gratitude notification to the at least one social media account of the social media system of the recipient.

In one or more of the above aspects, the computer system determines that the associated permission level for the gratitude notification prohibits posting a first data field of the plurality of data fields of the gratitude notification to the at least one social media account of the social media system of the recipient and communicates with the social media system to post the gratitude notification without the first data field to the at least one social media account of the recipient.

In one or more of the above aspects, the computer system stores the plurality of data fields of the gratitude notification in a notification database, wherein the notification database is stored on the at least one memory device.

In one or more of the above aspects, the computer system generates an interface to access and search the notification database, wherein the notification database includes a plurality of additional gratitude notifications and wherein the interface includes at least the following search fields: a recipient name and a sender name.

In one or more of the above aspects, the computer system provides public access to the gratitude notification in the notification database in accordance with the associated permission level.

In one or more of the above aspects, the computer system generates another gratitude notification using second data input from a second user device of a second sender wherein the another gratitude notification includes another plurality of data fields and wherein the another plurality of data fields includes at least the second sender, a second recipient, and a second donation or service data. The computer system obtains a third permission level for the another gratitude notification and/or one or more of the another plurality of data fields from the second user device of the second sender and obtains a fourth permission level for the another gratitude notification and/or the one or more of the another plurality of data fields from the second recipient. The computer system reconciles the third permission level and the fourth permission level to determine an associated permission level for the another gratitude notification and determines the associated permission level for the another gratitude notification prohibits posting the another gratitude notification to at least one social media account of a social media system of the second recipient. The computer system stores the another gratitude notification in the notification database with restriction for access only by the second sender and by the second recipient.

In one or more of the above aspects, the computer system communicates with the user device of the sender to display one or more graphical user interfaces (GUIs) on the user device and using the one or more GUIs, obtains the input data for the gratitude notification from the user device, wherein the one or more GUIs are configured to include one or more suggestions for completing the data input for the gratitude notification.

In one or more of the above aspects, the one or more GUIs displayed on the user device include the plurality of data fields for the gratitude notification, wherein the plurality of data fields further includes: a service description, a donation description, a date and/or time of a service or a donation, a personal note, and a delivery date and/or time.

In one or more of the above aspects, the one or more GUIs are configured to include an option to transmit an electronic card to the recipient.

In one or more of the above aspects, the computer system communicates a message to a recipient device or to the at least one social media account of the social media system of the recipient, wherein the message includes a hyperlink to at least one GUI that displays the gratitude notification and includes at least one data field for obtaining the second permission level for the gratitude notification and/or the one or more of the plurality of data fields from the recipient.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

FIG. 1 illustrates a schematic block diagram of a computing system environment including a gratitude system in accordance with one or more embodiments herein.

FIG. 2 illustrates a schematic block diagram of the gratitude system interworking with one or more third party systems in accordance with one or more embodiments herein.

FIG. 3 illustrates an exemplary embodiment of a notification database and data therein in accordance with one or more embodiments herein.

FIG. 4 illustrates a schematic block diagram of the gratitude system with a tiered architecture in accordance with one or more embodiments herein.

FIG. 5 illustrates a schematic block diagram of an exemplary graphical user interface (GUI) generated using the gratitude system in accordance with one or more embodiments herein.

FIG. 6 illustrates a schematic block diagram of another exemplary GUI generated using the gratitude system in accordance with one or more embodiments herein.

FIG. 7 illustrates a schematic block diagram of another exemplary GUI generated using the gratitude system in accordance with one or more embodiments herein.

FIG. 8 illustrates a schematic block diagram of another exemplary GUI generated using the gratitude system in accordance with one or more embodiments herein.

FIGS. 9A-9D illustrate a schematic block diagrams of methods of the gratitude system in accordance with one or more embodiments herein.

FIG. 10 illustrates a schematic block diagram of another embodiment of a computing system environment including the gratitude system in accordance with one or more embodiments herein.

FIG. 11 illustrates a schematic block diagram of an embodiment of a user device in accordance with one or more embodiments herein.

FIG. 12 illustrates a schematic block diagram of another embodiment of a user device in accordance with one or more embodiments herein.

### DETAILED DESCRIPTION OF THE INVENTION

The subject application references certain processes which are presented as a series of ordered steps. The steps described with respect to these processes are not to be understood as enumerated consecutive lists but could be performed in various orders and one or more steps may be removed or additional steps added while still embodying the invention described herein.

Where a term is provided in the singular, the inventors also contemplate aspects of the invention described by the plural of that term. As used in this specification and in the appended claims, the singular forms “a,” “an” and “the” include plural references unless the context clearly dictates otherwise, e.g., “an appliance” may include a plurality of appliances. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs, and materials are now described. All publications mentioned herein are incorporated herein by reference in their entirety. Where there are discrepancies in terms and definitions used in references that are incorporated by reference, the terms used in this application shall have the definitions given herein.

A gratitude system and method are described herein that is configured to generate, transmit, and track gratitude notices. The gratitude system, through a website or application, e.g., known as ThankApp™ or SuperThankApp™, includes a system and method for generating a gratitude notification, such as a Thank You note, to a recipient. The recipient may then agree for the gratitude notice to be posted to a social media service, e.g., Facebook®, Instagram®, LinkedIn®, TikTok®, and/or another social network. In one embodiment, the gratitude system communicates with the social network to post the gratitude notice. In another embodiment, the gratitude system is incorporated into the social network as an enhanced feature. The gratitude system also stores the plurality of generated gratitude notices in a public database that may be accessed and searched by a user. Thus, a user may search the database and obtain the gratitude notices sent by a particular sender or received by a particular recipient. The gratitude application may be a web-based application supported by an application web server that provides access to the gratitude application, e.g., online via a website. In another embodiment, the gratitude system includes a stand-alone application that is downloaded to a user device and is operable on a user device without access to the application web server or only needs to access the application web server or other devices for additional data and updates.

In use, in one exemplary embodiment, a sender (individual, nonprofit, political campaign, alumni association, company, organization, etc.) accesses the gratitude system, through a website or downloaded application, and generates a gratitude notification to a recipient. The gratitude system electronically transmits the gratitude notification to the recipient (individual, nonprofit, political campaigns, alumni association, company, organization, etc.) using contact information for the recipient, such as a text, email, Facebook account, Instagram account, or LinkedIn account. The gratitude notification includes an option to select a permission level to specify whether the gratitude notice, or data elements thereof, may be published on third party applications, such as Facebook, Instagram, LinkedIn and/or on a website for the gratitude system. If allowed by the selected permission level, the gratitude notification is posted on one or more social networks or the gratitude system website such that those accessing the social media of the recipient may view the gratitude notification. The gratitude notification may include one or more hyperlinks to retrieve more detailed information related to the gratitude notification. Thus, the gratitude system provides a public platform for those who wish to express and receive gratitude while also maintaining privacy for those who wish to remain anonymous.

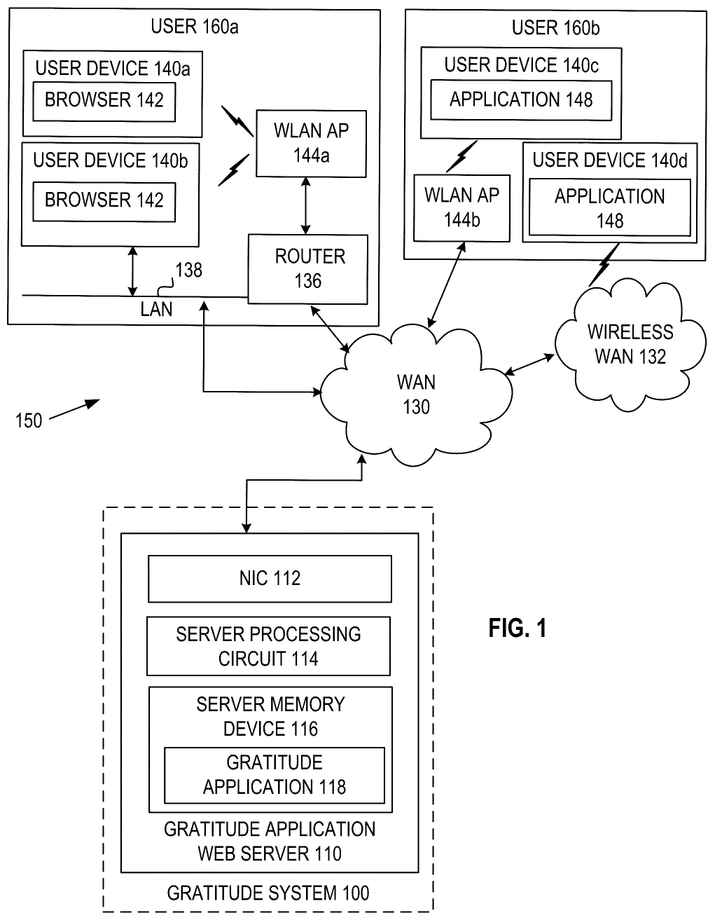

Referring now to FIG. 1, it illustrates a schematic block diagram of a computing system environment 150 including the gratitude system 100 in accordance with one or more exemplary embodiments. The gratitude system 100 includes at least one gratitude application server 110 configured to provide, e.g., a cloud-based application or service that allows access to the gratitude system 100 by browsers 142 on one or more user devices 160a-b via a wide area network (WAN) 130 or wireless WAN 132. The user devices 140a-d include any type of processing device, such as a smartphone, laptop, desktop, tablet, watch, television, vehicle, etc. The user devices 140a-d may also include user interface devices, such as keyboard, mouse, pen, voice input device, touch input device, a display, speakers, printer, etc. As used herein, the users 160a-b of the gratitude system 100 may include one or more of individuals, company, non-profit group, political party, or other organization that uses or licenses the gratitude system 100.

In one embodiment, the users 160a-b operate the user devices 140 to access the gratitude system 100 using a web browser 142, such as Goggle Chrome®, Microsoft Edge®, Apple Safari®, etc. The one or more web browsers 142 interact with the application web server 110 of the gratitude system 100 using one or more protocols. For example, the browsers 142 may submit HTTP or other type of protocol request messages to the application web server 110. The application web server 110 provides resources such as HTML files, data or other content and returns a response message to the browser 142. The browser 142 then displays the HTML files, data, or other content to the user 160a on the user device 140a-d as one or more graphical user interfaces (GUIs).

In another exemplary embodiment, a user application 148 may be downloaded from the application web server 110 and installed on the user devices 140a-d. The user application 148 may be operable on a user device 140a-d without access to the application web server 110 and/or communicate with the application web server 110 or other server for updates, data, content, or certain processes. For example, a standard client server technology architecture may be implemented, which allows users 160a-b of the gratitude system 100 to access information stored in the databases of the application web server 110 or other servers via custom user interfaces, Communication between software components and sub-systems are achieved by a combination of direct function calls, publish, and subscribe mechanisms, stored procedures, and direct SQL queries, however, alternate components, methods, and/or sub-systems may be substituted without departing from the scope hereof. Also, alternate embodiments are envisioned in which the user devices 140a-d may access one or more servers through a private network. The user devices 140a-d may host the private network with a server or other device including a client version of the gratitude system 100.

The computing system environment 150 includes a combination of one or more networks that are communicatively coupled to the gratitude system 100 and the user devices 140a-d, e.g., such as a wide area network (WAN) 130 or a wireless wide area network (Wireless WAN) 132. The WAN 130 includes the Internet, service provider network, other type of WAN, or a combination of one or more thereof. The Wireless WAN 132 includes a cellular network, such as a 4G or 5G network. The WAN 130 or Wireless WAN 132 are communicatively coupled directly to a user device 140a-d or coupled to the user devices 140a-d through an edge network, e.g., including a router 136, bridge (not shown), or other devices. The client router 136 may be coupled to a local network, including e.g., a local area network (LAN) 138 or WLAN access point (AP) 144a-b. The one or more networks work to communicatively couple the user devices 140a-d to the gratitude system 100. Alternate networks and/or methods of communicating information may be substituted without departing from the scope hereof.

The application web server 110 includes, e.g., a network interface card (NIC) 112 that includes a wired and/or wireless transceiver for wireless and/or wired network communications with one or more of the user devices 140a-d over the exemplary networks 130, 132 in the computing environment 150. The NIC 112 may also include authentication capability that requires an authentication process prior to allowing access to some or all the resources of the application web server 110. The NIC 112 may also include firewall, gateway, and proxy server functions.

The application web server 110 also includes a server processing circuit 114 and a server memory device 116. The server memory device 116 is a non-transitory memory device and may be an internal memory or an external memory. The memory device 116 may be a single memory or a plurality of memories. The memory device 116 may be a read-only memory, random access memory, volatile memory, non-volatile memory, static memory, dynamic memory, flash memory, cache memory, and/or any non-transitory memory device that stores digital information. The server processing circuit 114 includes at least one processor, such as a central processor unit (CPU), microprocessor, microcontroller, embedded processor, digital signal processor, media processor, field programmable gate array, programmable logic device, state machine, logic circuitry, analog circuitry, digital circuitry, and/or any device that manipulates signals (analog and/or digital) based on hard coding of the circuitry and/or operational instructions. The server memory device 116 stores computer-executable instructions which when executed by the server processing circuit 114, causes the gratitude system 100 to perform one or more functions described herein. For example, the server memory device 116 stores a gratitude application 118 including at least a portion of computer-executable instructions executed by the gratitude system 100 to perform the functions described herein.

The depicted computing system environment 150 is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like. The servers, memory devices, processing circuits, NICs, user devices, routers, and other network components shown in FIG. 1 are merely exemplary, and one or more devices may be omitted, added, or substituted without departing from the scope of the present invention.

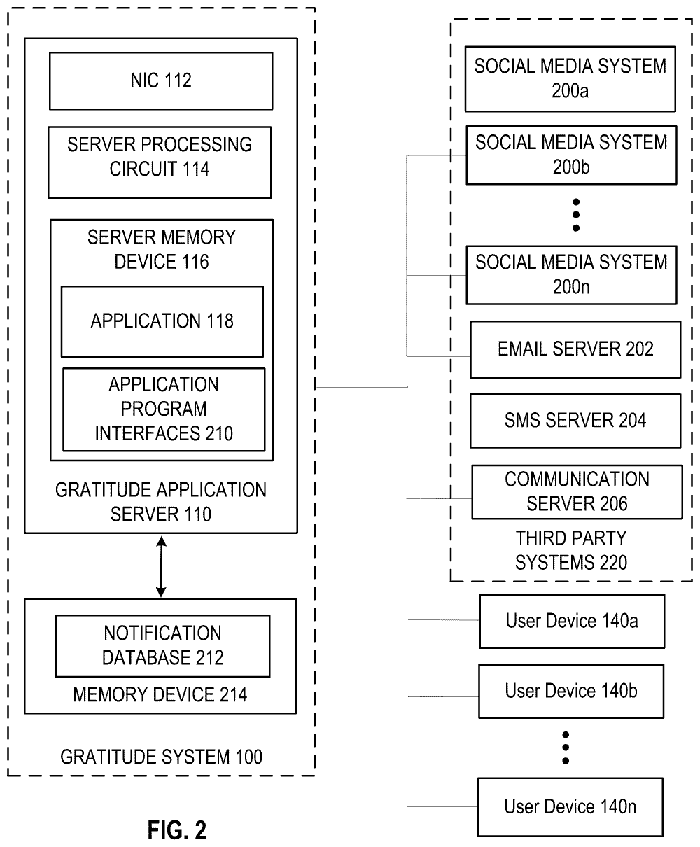

FIG. 2 illustrates a schematic block diagram of the gratitude system 100 interworking with one or more third party systems 220 in accordance with one or more exemplary embodiments. The gratitude system 100 includes application program interfaces (APIs) 210 configured to access one or more of third-party systems 220. The third-party systems 220 may include third party application servers, websites, services, databases, devices, and/or networks. In one embodiment, the third-party systems 220 include one or more social media systems 200a-n, such as LinkedIn®, Facebook®, Instagram®, TikTok®, X™ (aka, Twitter®), Snapchat®, etc. Additional and/or alternate social media systems or applications may also be accessed by the gratitude system 100. The gratitude system 100 may also access email servers 202 and/or a short message service (SMS) server 204, or instant messenger (IM) servers, or other communication applications servers 206, such as WhatsApp®, Skype®, Snapchat®, etc.

The gratitude system 100 further communicates with the one or more user devices 140a-b, as described with respect to FIG. 1. The users 160 may access the gratitude system 100 using the user devices 140a-b to perform one or more functions described herein. The users 160 can optionally create user profiles in the gratitude system 100 and/or social media systems 200a-n including associated contact data, such as email, text, phone number, social network accounts, physical address, etc. The user profiles may be associated with an individual user, a company, non-profit, school, retail, political party, government agency, informal group (such as a book club or child's sports team), or other public or private organization.

The gratitude system 100, e.g., through its website or application, provides users 160a-b with the ability to send and receive gratitude or thank you notifications to a recipient. Furthermore, with appropriate permissions, the gratitude notifications may be posted or viewable publicly on one or more selected social media systems 200a-n and/or a website operated by the gratitude system 100. For example, a user 160 may generate a gratitude notification using the gratitude system 100 and have the gratitude notification transmitted to a recipient via email, text, IM, notification in a Facebook account, direct message (DM) on Instagram, a Snapchat, or other social media account of the recipient, etc. When permission is granted by the sender and the recipient, the gratitude system 100 may post the gratitude notification on one or more of the social media accounts of the sender and/or of the recipient. Thus, the public may view the gratitude notification on the one or more social media accounts when permitted by the sender and the recipient. In addition, the gratitude system 100 may post the gratitude notification on a website operated by the gratitude system 100. The gratitude system 100 thus provides users 160, such as nonprofits, GoFundMe® causes, alumni associations, etc., the ability to thank donors publicly and thereby publicize their cause and possibly obtain more potential donors.

In addition, the gratitude system 100 may maintain a notification database 212 in a memory device 214 that includes the gratitude notifications and data associated therewith. The memory device 214 may be a separate memory device from the application web server 110 or incorporated into the application web server 110. In an embodiment, the gratitude system 100 provides public access to at least a portion of the data in the notification database 212. For example, when permission is granted by the sender and recipient of a gratitude notification, the gratitude notification, or portions thereof, may be accessed and searched in the database 212. The gratitude system 100 may provide a website or other public or private portal to access and search a public portion of the notification database 212. For example, the website may allow a public search for gratitude notifications generated for a particular individual recipient or organization. In response to the search request, the application web server 110 accesses the notification database 212 and provides a list of the publicly available gratitude notifications that meets the search criteria. Thus, the various acts of kindness and generosity performed by a person or organization may be searched and viewed. This ability may be valuable to potential employers deciding on whether to hire an individual or to colleges as part of the admission process or organizations determining an award recipient.

In addition, an individual or organization may search the notification database 212 and determine notifications generated by themselves over a time period. For example, at the end of the year, a user 160 may obtain a list of recipients of gratitude notifications from the user to identify persons who have helped the user through the year, and ensure to wish them happy holidays.

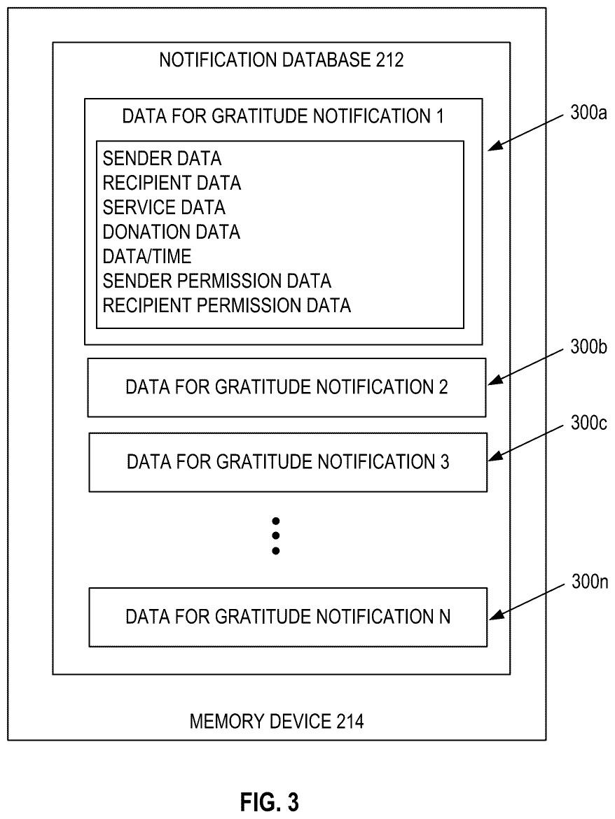

FIG. 3 illustrates an exemplary embodiment of a notification database 212 and data elements therein in accordance with one or more embodiments of the present invention. The notification database 212 may be stored in one or more memory devices 214 and may comprise multiple databases or data structures. The notification database 212 may include one or more databases capable of storing, organizing, sorting, filtering or otherwise manipulating data, including without limitation cloud-based databases, and may be included within or connected to one or more servers as described herein in any appropriate manner without departing from the scope hereof. In one embodiment, the notification database 212 may include a public portion with data accessible by the public and a private portion with data only accessible to the sender and/or recipient of a particular gratitude notification. The private portion and the public portion of the notification database 212 may be stored on a same device or different devices or multiple devices.

The data 300a-n associated with a gratitude notification and stored in the notification database 212 includes a plurality of fields, for example, sender data and recipient data. Individual data fields may include a name, email, phone number, one or more social media accounts, a physical address, etc. In some cases, the sender and/or receiver data includes account information for the gratitude system 100. For example, a user may be required to create a user account, e.g., with at least an email address and password, to generate a gratitude notification. However, a recipient may not be required to have a user account with the gratitude system 100 to receive the gratitude notification. The sender may input an email, phone number, Facebook account, WhatsApp number, or other contact data associated with the recipient. The recipient may thus receive the gratitude notification without creating a user account with the gratitude system 100.

The data 300a-n associated with a gratitude notification and stored in the notification database 212 may further include service data and/or donation data. The service and/or donation data elements include a description of the act of kindness, monetary donation, in-kind donation, or other reason for the gratitude notification. The data 300a-n associated with a gratitude notification and stored in the notification database 212 may also include a date and time that the gratitude notification was generated and/or when it was transmitted and/or when it was acknowledged, etc.

The data 300a-n associated with a gratitude notification and stored in the notification database 212 may further include sender and recipient permission data. The permission data includes one or more permission levels specified by the sender and/or recipient. The permission level defines whether the gratitude notification may be published publicly, e.g., on a social network, and/or accessed publicly through the website of the gratitude system 100. In some embodiments, the permission level may specify that some data fields associated with a gratitude notification may be published and/or publicly accessible while other data fields associated with the gratitude notification are to remain private. For example, a recipient may allow publication on a social network of the gratitude notification for a donation to a charity but request that the amount of the donation remain private. In another example, a sender may wish to acknowledge a recipient's help during an illness but prefers that their illness remain confidential. The sender may then specify for the service data to remain private or that only a generic descriptor, such as “Act of Kindness”, is published and/or publicly accessible. The permission levels may include publicly available, private to only the sender/recipient, available only to users of the gratitude system 100 having user accounts, available only to specified users of the gratitude system 100, available only to “friends” of sender and/or receiver on a social media system, etc. The sender and the recipient may thus control the accessibility of the data associated with the gratitude notification.

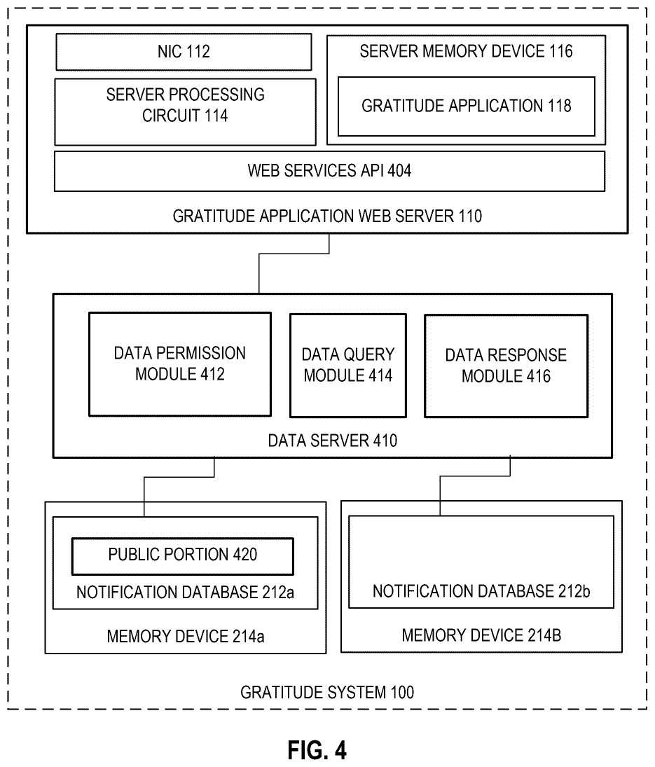

FIG. 4 illustrates a schematic block diagram of a gratitude system 100 with a tiered architecture for providing a website in accordance with one or more embodiments herein. In some embodiments, the gratitude system 100 hosts a web-based or cloud-based gratitude application 118 that allows access to the gratitude system 100 using a web browser 142 on one or more user devices 140. For example, the web browsers 142 allow the user devices 140 to interact with the application web server 110 via a Hypertext Transfer Protocol (“HTTP”) or other similar protocol. The application web server 110 handles the HTTP requests and provides content such as images, CSS, JavaScript files, HTML files, or other files to the browsers 142. The application web server 110 may transmit one or more HTML files or other types of files and/or transmit other data or content to the browsers 142. The browsers 142 generate one or more graphical user interfaces (GUI) using the files and data from the application web server 110. The NIC 112 on the application web server 110 includes a wireless and/or wired transceiver with authentication capability that requires an authentication process prior to allowing access to some or all the resources of the gratitude system 100, such as a login with a username and password, biometric identification, or other verification process. The NIC 112 may also include firewall, gateway, and proxy server functions. The application web server 110 also includes the gratitude application 118 which is a custom application built using a programming language like Python, Java, or Ruby.

The application web server 110 communicates over a private network with the data server 410. The data server 410 manages the notification database 212a-b. In an embodiment, the notification database 212a-b is stored as one or more databases on the one or more memory devices 214a-b. The memory devices 214a-b may be included as part of the data server 410 or may be separate devices.

This tiered architecture is more secure because the user devices 140a-n do not directly access the data in the data server 410 or memory devices 214a-b. The web services API 404 provides an interface for communication between the application web server 110 and the data server 410. The data server 410 may then access any requested data in the notification database 212a-b and provide the requested data to the application web server 110, e.g., for communication to the user devices 140. The data server 410 may include a data permission module 412 that determines the permission level for a data field and may store public data fields in a separate public portion 420 of the notification database 212a-b. Thus, data fields with a restricted permission level are separated and more secure. A data query module 414 may receive the data request from the web services API 404 and generate a search or data filter for searching the notification database 212a-b. The data response module 416 may receive the search results and generate a response to the web services API 404.

The servers, memory devices, and databases shown in FIG. 4 are merely exemplary, and servers and/or databases may be omitted, added, or substituted without departing from the scope of the present invention. In addition, different system architectures may be implemented that perform the functions described herein. The gratitude system 100 thus provides a special purpose computing system configured for provision of the new methods and functions described herein. The gratitude system 100 includes significant additional elements with tangible physical form and provides a practical application for performing one or more unique methods described herein that may only practically be performed by a computing system, considering the multitude of data, e.g., of the plurality of users, of the plurality of gratitude notifications, database management, and the generation of computer implemented interfaces with new functionality and communications with remote, third party processing devices.

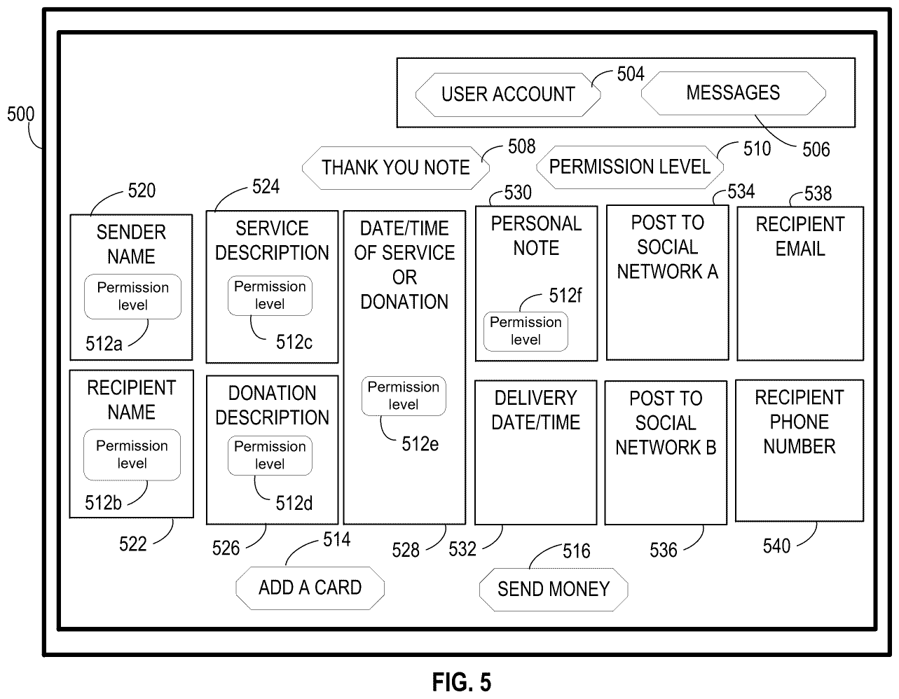

FIG. 5 illustrates a schematic block diagram of a graphical user interface (GUI) 500 that may be generated using the gratitude system 100 and displayed on one or more user devices 140a-d in accordance with one or more embodiments herein. The GUI 500 is merely exemplary to illustrate types of data fields displayed and functionality of the gratitude system 100. The fields, icons and data described with respect to this GUI 500 may be included on additional and/or alternate GUIs or in other ways than described herein.

In this exemplary GUI 500, a user may input data to generate a gratitude notification, e.g., a Thank you note. The GUI 500 may include a user account icon 504 that displays a current user of the gratitude system 100 that has logged into their user account. The GUI 500 may further include a messages icon 506 that when selected, displays messages for the user. These messages may include acknowledgement of prior gratitude notifications sent by the user, a notice that the user has received a gratitude notification, etc.

The GUI 500 indicates that a Thank You note (i.e., gratitude notification) has been selected with icon 508. Other types of notifications may be generated in one or more embodiments, such as Acknowledgements of a Thank You note, Congratulation notifications, Award notifications, etc. The GUI 500 further includes a permission level icon 510 to select whether the gratitude notification may be published and publicly available. The permission levels may include “private” or “public” or only “Friends” of the sender or other defined level. When private is selected, the gratitude system 100 will not post the Thank You note, or any data associated with the Thank You note, on a social network or its website. In addition, the gratitude system 100 will not allow access to the gratitude notification in its notification database 212 except by the sender and the recipient. Thus, other users may not view the gratitude notification in response to a search of the notification database 212. In addition to private or public, the permission levels may further include one or more of: only registered users of the gratitude system 100, only friends on a social network, only specific users of the gratitude system 100, or other defined levels.

The GUI 500 includes a plurality of data elements for the sender to complete including one or more of the following: sender name 520, recipient name 522, service description 524, donation description 526, data/time of the service/donation 528, and/or a personal note 530. The GUI 500 may provide suggestions for completing various fields. For example, for the donation/service description, the gratitude system 100 may suggest “Act of Kindness” or “Kind Words” or “Thoughtful Gift”, or “Generous Donation”, etc.

In addition, one or more of the data fields have an associated permission level icon 512a-f. The user may select the icons 512a-f to specify a permission level for the associated data field. For example, when a sender is thanking the recipient for flowers in the hospital, the sender may want their name to remain anonymous for medical privacy. The sender may then select the permission level icon 512a associated with the data element “Sender Name.” In response, the GUI 500 displays a drop-down menu including different permission levels. The sender may then select “Private” as the permission level for the data element “Sender Name”. The sender may select that the other data elements have a permission level of “Public” using the other icons 512b-f, so that others may know the recipient performed the kind act of sending flowers to “anonymous” in the hospital. The sender may thus control the permission level and accessibility of individual data elements of the Thank You note prior to sending to the recipient.

The GUI 500 may further include data fields 534, 536 to indicate which Social Networks to post the gratitude notification and data fields to insert contact information for the recipient including recipient email 538, recipient phone number 540, or other contact information, such as one or more social network user ids, IM, etc. The sender may also specify a delivery data/time 532 of the gratitude notification. For example, the sender may prepare Thank You notes to hosts of an event and delay the delivery until after the event. The GUI 500 may further include an icon 514 with a hyperlink to a GUI to generate an electronic card (eCard) and have the eCard attached to the Thank You note. The GUI 500 may further include an icon 516 to an application to send money, such as PayPal® or Zelle® or Venmo®. The GUI 500 may also include additional and/or alternate data fields, menus, icons, etc. to those described herein.

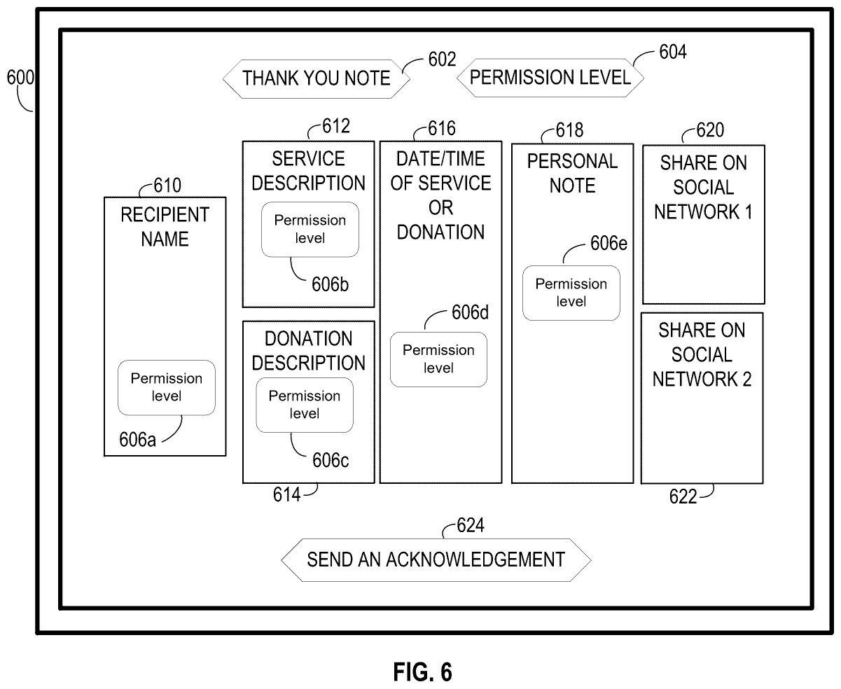

FIG. 6 illustrates a schematic block diagram of a graphical user interface (GUI) 600 that may be generated using the gratitude system 100 and displayed on a user device 140 in accordance with one or more embodiments herein. The GUI 600 is merely exemplary to illustrate types of data displayed and functionality of the gratitude system 100. The fields, icons and data described with respect to this GUI 600 may be included on additional and/or alternate GUIs or in other ways than described herein.

In this exemplary GUI 600, a gratitude notification, i.e., a Thank You note 602, are displayed on a recipient device 140. The recipient may receive an alert through email, text, an icon or notification on a Facebook page, Instant Messenger, etc. that the recipient has received a Thank You note. When an icon in the alert is selected by the recipient, it activates a hyperlink with the IP address to the application web server 110 for the gratitude system 100 and/or to a particular page of a website generated by the application web server 110 that displays the Thank You note. The recipient may then view the details of the Thank You note, e.g., as shown in FIG. 6.

In an embodiment, the GUI 600 includes one or more “Share on Social Network” icons 620, 622. When the recipient wants to post the Thank You note to a social media system 200a-n, the recipient may select one or more of the “Share on Social Network” icons 620, 622. When selected, the gratitude system 100 may request a user ID/login for the recipient on the social network if not already known. The gratitude system 100 will then communicate with the social network as described with respect to FIG. 2 to post the Thank You note to the recipient's account on the selected one or more social media systems 200a-n.

When the recipient prefers that the Thank You note remain private, the recipient may select the permission level icon 604 associated with the gratitude notification and then select “Private”. When private is selected, the gratitude system 100 will not post the Thank you note, or any data associated with the Thank You note on a social media system 200a-n or its website. In addition, the gratitude system 100 will not allow the gratitude notification to be publicly accessible in its notification database 212, except for the sender and the recipient. Thus, third party users may not view the gratitude notification in response to a search of the notification database 212. The permission levels may further include one or more of: only registered users of the gratitude system 100, only friends on a social network, only specific users of the gratitude system 100, etc.

The GUI 600 may further include permission level icons 606a-e associated with particular data fields in the Thank You note, such as the recipient's name 610, service description 612, donation description 614, date/time of the service/donation 616, or the personal note 618. The recipient may select a permission level for one or more of the plurality of data fields. For example, the Thank You note may specify a monetary amount in the donation description data field 614. The recipient may select “Private” as the permission level 606c for the donation description data field 614 so that the amount of the donation is not published or accessible. When the gratitude system 100 transmits the gratitude notification to a social network, it will not include the donation description data field 614. Instead, it may only provide a generic description of “A Donation”. In addition, the gratitude system 100 will not make the donation description data field 614 publicly available in its notification database 212, except for the sender and the recipient. Thus, users may view the gratitude notification, but not the donation description data field 614, in response to a search of the notification database 212. In another example, the recipient may select “Private” as the permission level for the personal note data field 618 so that the personal note from the sender is not published or accessible. When the gratitude system 100 transmits the gratitude notification to a social network, it will not include the personal note data field 618. In addition, the gratitude system 100 will not make the personal note data field 618 publicly available in its notification database 212, except for the sender and the recipient. Thus, third party users may view the gratitude notification, but not the personal note data field 618, in response to a search of the notification database 212. The recipient is thus able to control the accessibility of individual data elements of the Thank You note while still posting the Thank You note to social networks and to the gratitude system website.

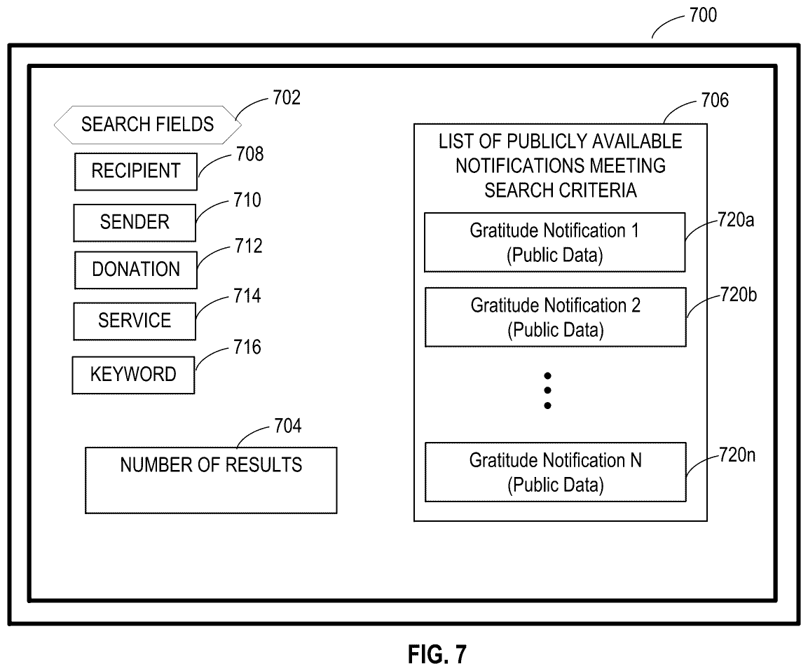

FIG. 7 illustrates a schematic block diagram of a graphical user interface (GUI) 700 that may be generated using the gratitude system 100 and displayed on a user device 140a-d in accordance with one or more embodiments herein. The GUI 700 is merely exemplary to illustrate types of data displayed and functionality of the gratitude system 100. The fields, icons and data described with respect to this GUI 700 may be included on additional and/or alternate GUIs or in other ways than described herein.

In this exemplary GUI 700, the gratitude system 100 generates an interface to the notification database 212 including a search tool for users to search for gratitude notifications that have been generated by the gratitude system 100 and stored in the notification database 212. One or more search fields 702 may be selected using the GUI 700. For example, the search fields 702 include one or more of recipient 708, sender 710, donation 712, service 714, keyword 716, etc. In response to the search request, the gratitude system 100 searches the notification database 212 for gratitude notifications that meet the requested search fields. The gratitude system 100 may determine and display a number of results 704 that are publicly available that meet the criteria. In another embodiment, the gratitude system 100 may also determine and include in the display the number of results that are not publicly available and cannot be accessed. Thus, a user may determine that additional acts of kindness were performed by a recipient but were selected to remain private.

A list 706 of the publicly available notifications 720a-n that meet the search criteria are displayed. The display may further include hyperlinks to view more details of each of the gratitude notifications. When displaying a gratitude notification, the gratitude system 100 only provides access to data elements associated with the gratitude notification that have a permission level that is “public” or other permission level that includes the user.

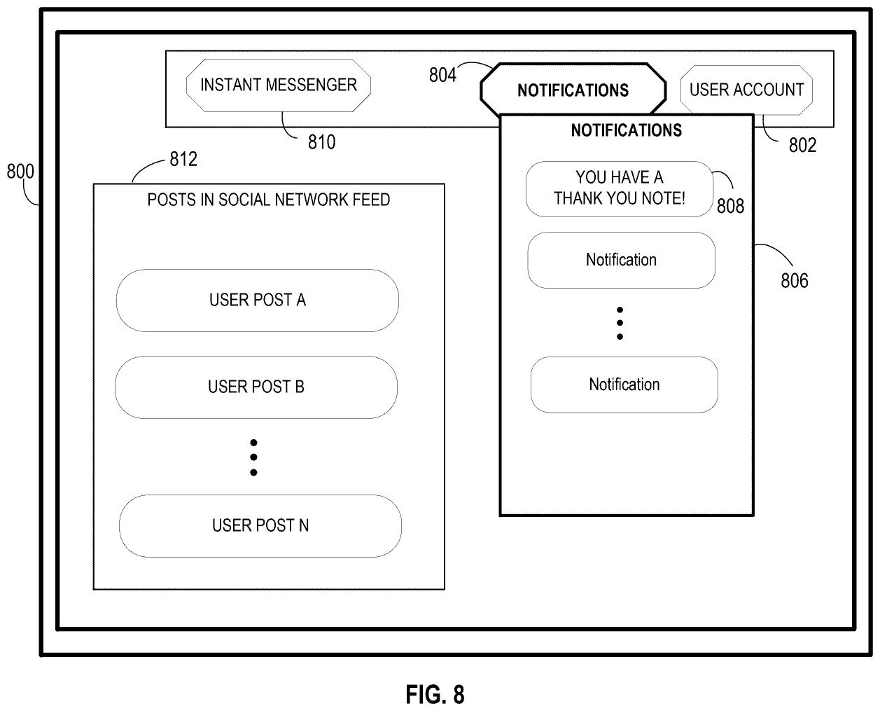

FIG. 8 illustrates a schematic block diagram of an exemplary GUI 800 for interworking with a social media system 200a-n by the gratitude system 100. In an embodiment, the gratitude system 100 obtains input data from a sender for a gratitude notification, such as a Thank You note, to transmit to a recipient via a social media system 200a-n. The gratitude system 100 communicates with the social media system 200a-n to generate an instant messenger (IM) message or other type of notification of the Thank You note to the recipient. The social media system 200a-n then generates a GUI 800 when the recipient logs into their user account 802. The GUI 800 includes, e.g., a list or feed of posts 812 from various users of the social network. The GUI 800 illustrates the IM icon 810 and a notifications icon 804 that when selected, generates a display 806 of messages or notifications including the notification 808 of the Thank You note.

The recipient may then select the notification 808 and view the Thank You note, e.g., either in the social media system 200a-n or through a hyperlink to the website of the gratitude system 100. The recipient may then select a permission level for the Thank You note and/or permission levels for the one or more individual data elements. The recipient may thus choose to post the Thank You note to their account in the social media system 200a-n and/or to other social media systems 200a-n. Though a notification 808 of the Thank You note is provided in this example, the Thank You note may be communicated as a message in Instant Messenger 810 or via email or via text or through other communication application.

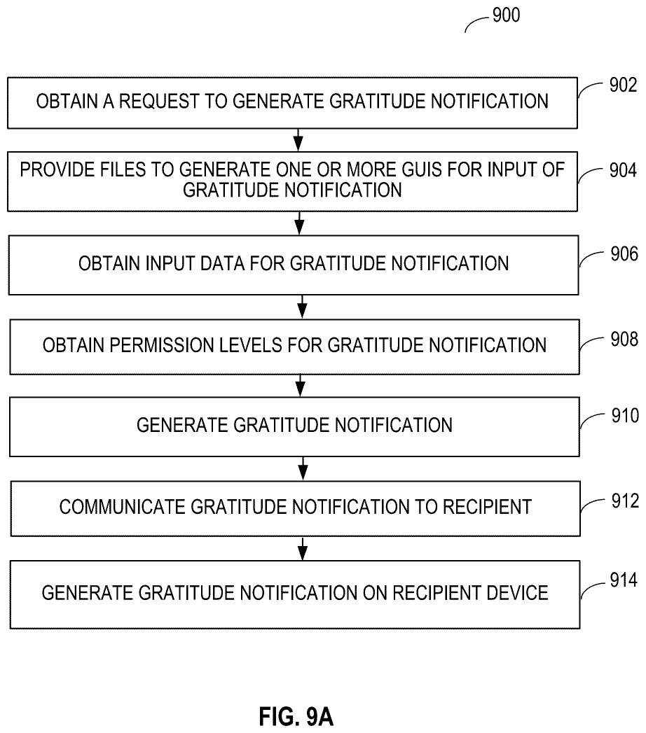

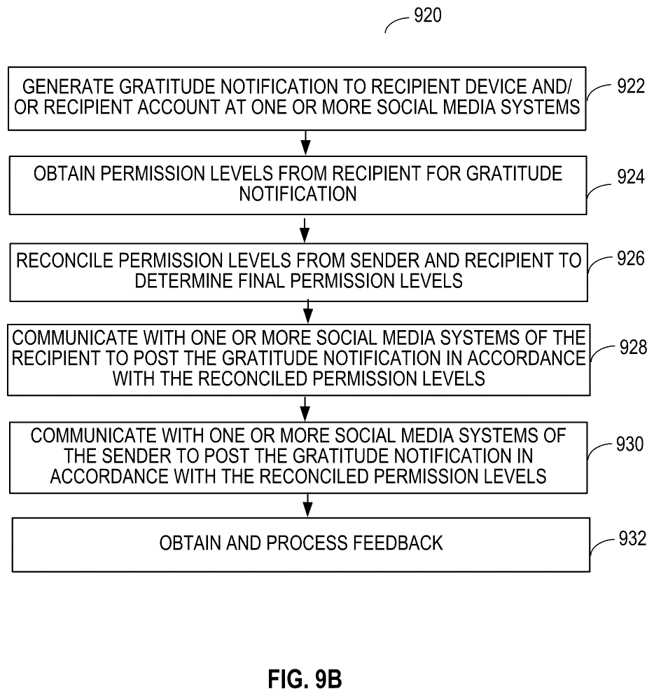

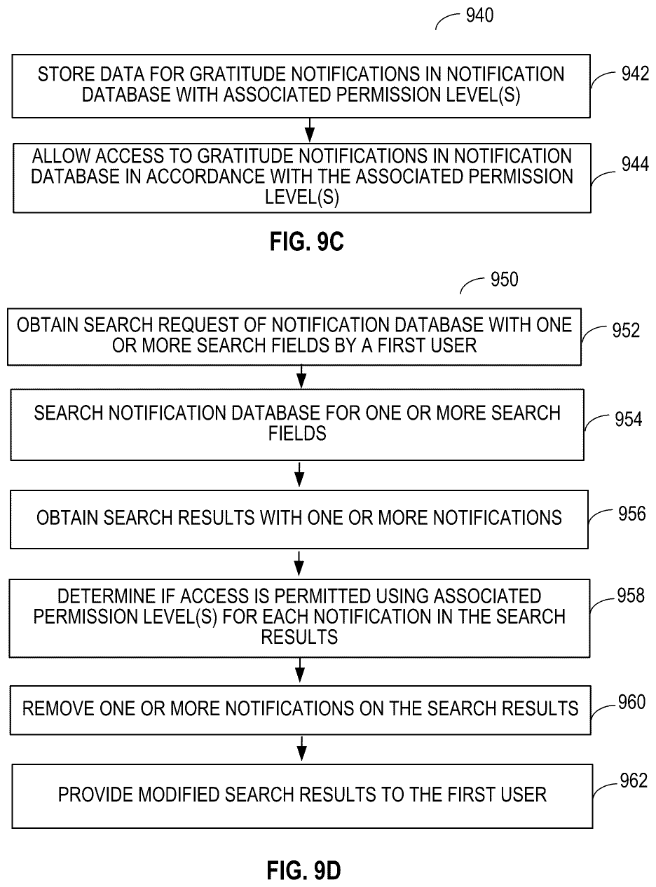

FIGS. 9A-D illustrate schematic block diagrams of methods of the gratitude system 100 according to one or more embodiments herein. Though the steps in the methods are illustrated as a sequential process, the steps may be performed in parallel or concurrently or may be re-arranged. Additional and/or alternate steps may also be performed as part of the methods. The methods may be performed using one or more of: an application 148 installed on a user device 140 or by the application web server 110 interacting with a web browser 142 on a client device 140 or by the application web server 110 interacting with a client application installed on a user device 140 or using other devices and configurations.

Referring to FIG. 9A, a method 900 is described for generating a gratitude notification. The gratitude system 100 obtains a request to generate a gratitude notification, e.g., from a registered user. The gratitude notification may include a Thank You note, Award notification, Congratulations notification, etc. In response, the gratitude system 100 generates HTML or other web files and transmits to a user device 142 at 904. The user device 140 uses the web files to generate one or more GUIs on the user device 142 of the registered user using an application 148 on the user device 140 or using a web browser 142 on the user device 142 or otherwise. The one or more GUIs include data fields or menu selections to receive user inputs of data elements for the gratitude notification. The data elements may include a sender name, recipient name, donation/service description, personal note, date/time, or other information, as described with respect to FIG. 5. In addition, the one or more GUIs include data fields or menu selections to receive user inputs of a permission level for the one or more data elements and/or for the entirety of the gratitude notification.

The data inputs for the gratitude notification are obtained at step 906, and the permission levels for the gratitude notification are obtained and processed at 908. The gratitude notification is generated at step 910, e.g., by an application 148 on the user device 140 or an application web server 110 or otherwise. In some implementations, the gratitude system 100 may include a sentiment analysis module employing a trained natural language processing (NLP) engine. Upon receipt of unstructured textual input from a sender (e.g., a freeform thank-you message in the personal note field), the engine classifies the sentiment into one or more categories such as “joyful,” “appreciative,” “solemn,” or “celebratory.” Based on this sentiment classification, the system dynamically applies a matching visual or stylistic theme to the gratitude notification. Themes may include variations in font style, background imagery, color palette, or animation. In an embodiment, the NLP engine is also configured to suggest alternate phrasings of the sender's message to conform with a selected tone preference. Tone presets may include “formal,” “casual,” “playful,” or “professional.” Suggestions may be generated using transformer-based models trained on a corpus of thank-you messages and social expressions, and may be presented as editable drafts for the sender's confirmation.

The gratitude notification is electronically transmitted at step 912 to the recipient using email, text, instant messenger (IM), or through a notification or message in one or more social media systems 200a-n. The recipient views the gratitude notification, e.g., by selecting a hyperlink that downloads one or more web files at 914 or using the gratitude application 118 on the recipient's user device 140a-d. The user device then generates the gratitude notification GUIs, e.g., using the web files and a web browser 142.

FIG. 9B illustrates a method 920 for posting a gratitude notification to a user account on a social media system 200a-n. The gratitude notification transmitted to a recipient includes one or more prompts or icons to select a permission level for the gratitude notification and/or permission levels for the one or more individual data elements, e.g., as shown with respect to FIG. 6. The one or more GUIs also display the sender's selected permission levels, as the default. The recipient can then select additional permission levels or more restrictive permission levels at 924.

The gratitude system 100 then reconciles the permission levels from the sender and the recipient at 926, e.g., by selecting the more restrictive permission level. For example, when the sender selected “Public” as a permission level for a data element, but the recipient selected “Private” for the data element, then the more restrictive permission level of “Private” is determined for the data element. In another embodiment, the gratitude system 100 includes a context-aware privacy module configured to enhance the reconciliation of sender and recipient permission levels. This module may ingest contextual metadata including, but not limited to, the time of day, the type of device used to submit the gratitude notification (e.g., mobile vs. desktop), geolocation information, or inferred emotional context from message tone. In other embodiments, a machine learning model may infer recipient preferences in cases where explicit permission levels are not provided. The inference may be based on the recipient's historical approval behavior, social graph proximity, or prior engagement with similar notifications. For example, if a recipient has previously accepted public sharing of gratitude notifications from specific senders or during specific events, the system may use that data to assign a provisional permission score. A predictive consent engine may optionally be implemented using a classification model trained to estimate the probability of approval by a given recipient under varying contextual and message-related factors. This estimation may be used to trigger conditional workflows (e.g., delayed posting, automated requests for clarification, or deferred public display).

The gratitude system 100 processes and analyzes the first and second permission levels, e.g., using the machine learning model trained on historical sender-recipient interactions, gratitude notification metadata, and prior privacy settings to reconcile any conflicts between the first and second permission levels, and to determine an associated permission level for the gratitude notification. For example, the machine learning model is a supervised learning model trained on labeled training data comprising gratitude notification attributes and reconciled permission outcomes. The machine learning model adjusts its reconciliation outputs based on user override actions or feedback signals indicating user satisfaction with prior publication outcomes. The machine learning model is further configured to analyze and recommend default permission levels for future gratitude notifications based on contextual similarity to previously reconciled notifications.

In an embodiment, the machine learning model incorporates contextual data including time of day, device type, or geographic location to further refine reconciliation of permission levels. The machine learning model infers the sender's and/or recipient's permission level in the absence of explicit input, based on historical behavioral data and social graph analysis. For example, the machine learning module includes a predictive model trained to estimate the likelihood that a recipient will approve public sharing, prior to actual reconciliation. The predictive model is trained with user-specific or group-specific training data to tailor predictions to demographic, cultural, or organizational contexts. The gratitude system 100 includes a user dashboard interface to review and modify the machine learning model's rationale or prediction before publication.

In some embodiments, the gratitude system 100 includes an interpretability interface or dashboard accessible to one or both parties (sender and/or recipient), allowing them to view the rationale behind the system's recommendation. The rationale may include weightings assigned to various factors, including historical behavior, contextual data, or model confidence scores. The interface may allow users to override or adjust the recommendation and to provide structured or freeform feedback, which is recorded and may be fed back into the system for retraining or model adjustment. Additionally, the gratitude system 100 may be configured to support user-specific or organization-specific model profiles. In this mode, the machine learning model may be trained or fine-tuned on local or segmented datasets specific to a group, demographic, or institution. This customization allows the system to reflect cultural norms or group-level privacy expectations.

The gratitude notification is posted by the gratitude system 100 on one or more social media systems 200a-n of the recipient when permissible in accordance with the reconciled permission levels at step 928. The gratitude notification is also displayed on the website for the gratitude system 100. The gratitude notification is also posted by the gratitude system 100 on one or more social media systems 200a-n of the sender when permissible in accordance with the reconciled permission levels at step 930. At 932, the gratitude system 100 obtains and processes feedback, e.g., from recipients or third-party viewers of public gratitude notifications. Feedback may be explicit (e.g., rating buttons or comments) or implicit (e.g., engagement signals such as views, shares, or time spent). This feedback is stored in association with the originating gratitude notification and may be used to retrain the machine learning model over time.

In an embodiment, the gratitude application 118 is implemented as part of another application or platform, such as a third-party communication platforms including email clients (e.g., Google Gmail®, MS Outlook®) or enterprise messaging platforms (e.g., Slack®, MS Teams™), a Customer Relationship Management (CRM) systems (such as Salesforce®), or fundraising platforms. The integration may be facilitated through browser extensions, APIs, or platform software development kits (SDKs). Upon detecting an outbound message or reply in progress, the integrated gratitude application 118 accesses contextual metadata from the message, such as recipient address, domain, prior communication content, and sender history. An NLP-based module generates one or more suggested gratitude notifications that match the inferred relationship role and tone, which are then presented in-line within the communication interface for user selection. The suggested messages includes various selectable tones, contexts, lengths, vigor, and structure presets. The gratitude application 118 logs the selected suggested message and recipient classification to a centralized gratitude analytics database.

FIG. 9C illustrates a method 940 for generating the notification database 212 in the gratitude system 100. At 942, the data for a plurality of gratitude notifications is stored in the notification database 212 including the permission levels associated with each of the plurality of gratitude notifications. For example, the permission level(s) for the sender and recipient of a gratitude notification is stored as well as the reconciled or associated permission level. In some embodiments, the system maintains a version-controlled record of each gratitude notification, including a timestamped log of permission level assignments, overrides, and changes. Each revision of the gratitude notification may be stored with a unique identifier and linked to audit trails for compliance or administrative review.

The gratitude system 100 then allows or restricts access to the data for a gratitude notification in accordance with the associated permission level at 944. A sender and/or receiver may change their permission level, e.g., provided authentication is performed to confirm their identity. The gratitude system 100 will then determine a new reconciled permission level and determine whether the gratitude notification may be publicly accessible in view of the change.

FIG. 9D illustrates a method 950 for accessing and searching the notification database 212 in the gratitude system 100. At 952, a search request including one or more search terms or fields is obtained from a first user device 140a-d. For example, the search terms or fields include one or more of recipient, sender, donation, service, keyword, etc. In response to the search request, the notification database 212 is searched for gratitude notifications that meet the requested search fields at 954 and search results are obtained with one or more gratitude notifications at 956. The associated permission levels for the search results are then processed to determine whether access is permitted to each of the gratitude notifications in the search results at 958. For example, one or more gratitude notifications may be removed if their associated permission levels do not allow access to the first user at 960. A modified search result of the gratitude notifications is then generated and communicated to the first user device 140a-d at 962. The modified search results only provides access to data elements associated with the gratitude notifications that have a permission level that is “public” or other permission level that includes the first user.

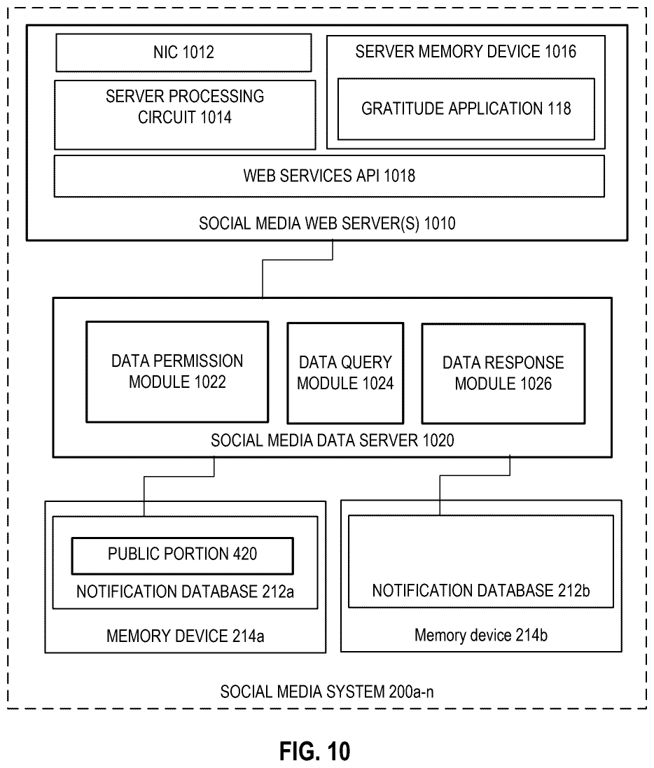

In an embodiment shown in FIG. 10, the gratitude system 100 is incorporated into at one of the social media systems 200a-n. The user devices 140a-n access the social media system 200a-n to perform the functions described herein with respect to the gratitude system 100. The users create user profiles in the social media system 200a-n including associated contact data, such as email, text, phone number, social network accounts, physical address, etc. The user profiles may be associated with an individual user, a company, non-profit, school, retail, political party, government agency, informal group (such as a book club or child's sports team), or other public or private organization. The social media system 200a-n incorporates the gratitude system 100 to provides users 160a-b with the ability to send and receive gratitude or thank you notifications to a recipient and publicly or privately post the notifications to other user accounts in the social media system 200a-n.

In an embodiment, the social media system 200a-n includes one or more social media web servers(s) 1010 including a network interface card (NIC) 1012 or separate load balancer device that provides load balancing and authentication capability to some or all the resources of the social media system 200a-n. The NIC 1012 includes a wireless or wired transceiver with firewall, gateway, and proxy server functions. The social media web server 1010 includes a server processing circuit 1014 and server memory device 1016 that stores the gratitude application 118. The gratitude application 118 is a custom application built using a programming language like Python, Java, or Ruby and incorporated into the social media system 200.

The social media web server 1010 communicates over a private network with the social media data server 1020. The social media data server 1020 manages the social media data, including the notification database 212a-b. In an embodiment, the notification database 212a-b is stored as one or more databases on the one or more memory devices 214a-b in the social media system 200. The memory devices 214a-b may be included as part of the social media data server 1020 or may be separate devices.

This tiered architecture is more secure because the user devices 140a-n do not directly access the data in the social media data server 1020 or memory devices 214a-b. The web services API 1018 provides an interface for communication between the social media web server 1010 and the social media data server 1020. The social media data server 1020 may then access any requested data in the notification database 212a-b and provide the requested data to the social media web server 1010, e.g., for communication to the user devices 140a-d. The social media data server 1020 may include a data permission module 1022 that determines the permission level for a data field and may store public data fields in a separate public portion 420 of the notification database 212a-b. Thus, data fields with a restricted permission level are separated and more secure. A data query module 1024 may receive the data request from the web services API 1018 and generate a search or data filter for searching the notification database 212a-b. The data response module 1026 may receive the search results and generate a response to the web services API 1018.

The servers, memory devices, and databases shown in FIG. 10 are merely exemplary, and servers and/or databases may be omitted, added, or substituted without departing from the scope of the present invention. In addition, different system architectures may be implemented that perform the functions described herein. The social media system 200a-n thus provides a special purpose computing system configured for provision of the new methods and functions described herein. The social media system 200a-n includes significant additional elements with tangible physical form and provides a practical application for performing one or more unique methods described herein that may only practically be performed by a computing system, considering the multitude of data, e.g., of the plurality of users, of the plurality of gratitude notifications, database management, and the generation of computer implemented interfaces with new functionality and communications with remote, third party processing devices.

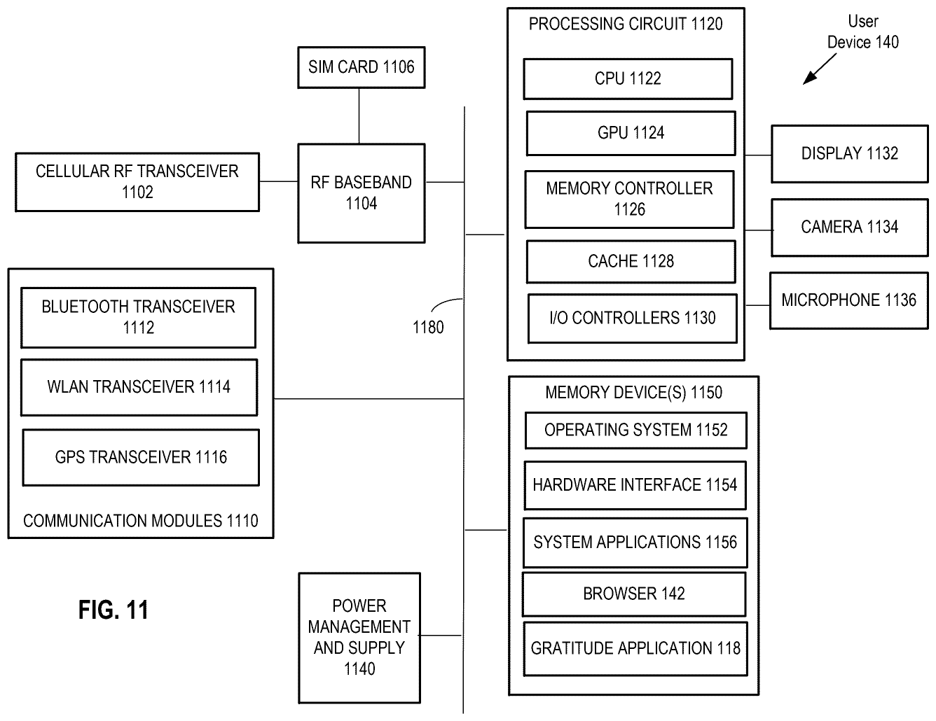

FIG. 11 illustrates a schematic block diagram of an embodiment of at least one of the user devices 140a-n. In this example, the user device 140a-n is a mobile device. The mobile device includes a cellular RF transceiver 1102, RF baseband 1104 and Subscriber Identity Module (SIM) card 1106 to connect to and authenticate with a cellular network for services like calls, texts, and data access. The cellular RF transceiver 1102 may be used to connect to a wide area network, such as the Internet, through the cellular network. The mobile device may include additional communication modules 1110, such as a Bluetooth transceiver 1112, WLAN transceiver 1114, and/or GPS transceiver 1116. The WLAN transceiver 1114 can also be used to connect to a wide area network, such as the Internet, e.g., through an Internet service provider.

The mobile device has one or more processing circuits 1120, such as a System-on-a-Chip (SoC), that integrate a Central Processing Unit (CPU) 1122, Graphical Processing Unit (GPU) 1124, memory controller 1126, memory cache 1128, Input/Output (I/O) controllers 1130 and/or other components. The I/O controllers 1130 interface with one or more peripherals, such as a display 1132, camera 1134, microphone 1136, etc. Power Management and Supply 1140 includes a battery and circuitry for managing power consumption and charging of the mobile device 100.

An operating system (OS) 1152, such as Android® OS developed by Google LLC or iOS® developed by Apple® Inc., is installed on the mobile device to control and operate the components of the mobile device. The operating system 1152 is stored on one or more non-volatile memory devices 1150, such as a read-only-memory (ROM). The operating system 1152, including any runtime components such as Android Runtime (ART) or iOS Runtime, executes applications on the mobile device, such as the gratitude application 118 and/or the browser 142. A hardware interface 1154 or Hardware Abstraction Layer (HAL) provides an interface between the operating system 1152 and the peripherals. System Applications 1156 includes pre-installed applications like text messenger or phone. A bus 1180 communicatively couples the various components of the mobile device.

The user device 140a-n includes a browser 142 and/or gratitude application 118 to perform the functions described herein. The gratitude application 118 may be pre-installed on the mobile device or downloaded and installed, e.g., from an application store/server such as Google Play® or Apple App Store® or from another source. In an embodiment, the gratitude application 118 includes processor-readable instructions, data structures, program modules, application-program interfaces (“APIs”), etc. that when executed by the processing circuit 1120, causes the mobile device 100 to perform one or more functions described herein. For example, the program modules include routines, programs, objects, components, data structures, etc. that perform tasks or implement particular abstract data types. In another embodiment, the mobile device connects to the gratitude system 100 and/or the social media system 200 using the web browser 142 to perform the functions described herein.

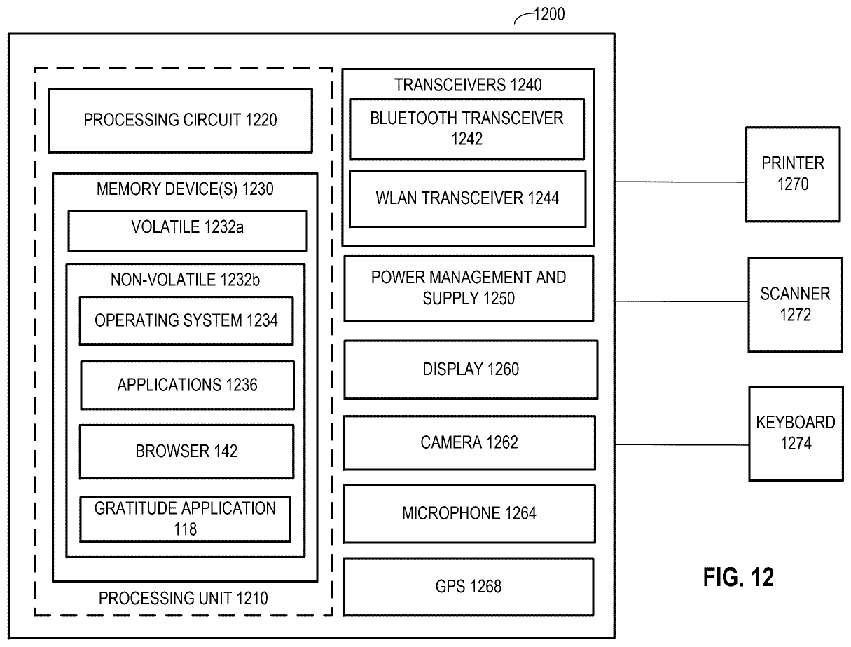

FIG. 12 depicts a schematic block diagram of another exemplary user device 140a-d that, in this example, includes a personal computer or laptop. The user device 140a-d includes a processing unit 1210 having at least one processing circuit 1220 and one or more memory devices(s) 1230. Depending on the exact configuration and type of the user device 140a-d, the memory devices 1230 may include volatile memory 1232a (such as, random access memory (“RAM”)) and non-volatile memory 1232b (such as read-only memory (“ROM”), flash memory, etc.), or some combination of the two. Additional storage may also be included, such as removable storage or non-removable storage, including, but not limited to, magnetic or optical disks or tape, thumb drives, and external hard drives, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium or any other available storage media that can be accessed by the user device 140a-n.

The non-volatile memory 1232b includes an operating system, such Apple®, and/or Windows® operating systems and applications 1236. One of the applications may include the gratitude application 118 and/or browser 142. The gratitude application 118 includes computer-readable instructions, data structures, program modules, application-program interfaces (“APIs”), etc. that when executed by the processing circuit 1220, causes the user device 140a-d to perform one or more functions described herein. For example, the program modules include routines, programs, objects, components, data structures, etc. that perform tasks or implement particular abstract data types. Such programs may be implemented in a high-level procedural or object-oriented programming language to communicate with the computer device. However, the program(s) can be implemented in assembly or machine language, if desired. In any case, the language may be a compiled or interpreted language and combined with hardware implementations. Additionally and/or alternately, the mobile device connects to the gratitude system 100 and/or the social media system 200 using the web browser 142 to perform the functions described herein.

The user device 140a-d further includes one or more transceivers 1240, such as a Bluetooth transceiver 1242, WLAN transceiver 1244, and/or other wireless or wired transceivers, that allow the computing device to communicate with other devices over one or more networks. Such one or more transceivers include computer-readable instructions, data structures, program modules and/or other data, to transmit a modulated data signal such as a carrier wave or other transport mechanism and includes any information delivery media. By way of example, and not limitation, communication media includes wired media such as a wired network or direct-wired connection, and wireless media such as acoustic, radio frequency (“RF”), infrared and other wireless media. The user device 140a-d may further include a power management and supply 1250 that includes a battery and components for charging and managing the batter power. The user device 140a-d may further include various input/output (I/O) devices, such as a display 1260 or touch screen, touch pad, keyboard, printer, speaker, mouse, etc. The user device 140a-d may also include a camera 1262, microphone 1264 and GPS system 1268. One or more peripheral devices may be coupled to the computing device, e.g., using the Bluetooth transceiver 1242, or a USB port, or other wireless or wired means, such as a printer 1270, scanner 1272 and keyboard 1274.

The gratitude system 100 provides a system and method to generate Thank You notes and/or other gratitude notifications by a sender (individuals, nonprofits, political campaigns, alumni associations, companies, etc.) to thank or show appreciation for a recipient (individuals, nonprofits, political campaigns, alumni associations, companies, etc.). The Thank You note may be transmitted to the recipient using an application on a recipient's device, a website, text, email, instant messenger, Facebook, Instagram, LinkedIn, or other social networks. The gratitude system 100 also includes a privacy system for the sender and receiver to select a permission level of the Thank You note and for one or more individual data elements. When the permission level permits, the Thank You note may be published on a gratitude system website and/or on a social network account of the sender and/or recipient. The gratitude system 100 may also provide an option for the sender to purchase and attach a gift card or send money using the gratitude system 100 or a third-party app (such as PayPal). The gratitude system 100 may provide suggestions to help a sender draft appropriate thank you messages for the occasion, send the thank you to a group of people, schedule when the thank you note is sent to the recipient, or elect to generate and send a more elaborate electronic card. Upon receiving the thank you note, the recipient may opt to display a Thank You confirmation, message, insignia and/or medallion on their social media, which those viewing their social media can click on and obtain additional information on the thank you note. In use, the gratitude system 100 provides a system and method for nonprofits, funding campaigns (such as a GoFundMe®), political party, alumni association, etc., the ability to thank donors publicly and thereby publicize their cause and perhaps obtain more potential donors.

In addition, the gratitude system 100 stores a notification database including Thank you notes or other gratitude notifications and provides a website or portal for searching the database. The publicly shared Thank You notes received by an individual or organization may be searched and listed through the website or portal. This information may be valuable to potential employers, college admissions, or even a potential date. This information may also be valuable to both the sender and the recipient of Thank You notes by preserving a list of those who have helped them.

These benefits, advantages and solutions to problems that have been described above are merely exemplary. Any benefit, advantage, solution to a problem, or any element that may cause any particular benefit, advantage, or solution to occur or to become more pronounced, are not to be construed as critical, required, or essential features or components of any or all the claims. Additional and/or alternate benefits, advantages and solutions may also become apparent in these embodiments.

It should be noted that the foregoing aspects of the disclosure are merely examples and are not to be construed as limiting the scope of the claims. The description of the embodiments herein is intended to be illustrative, and not to limit the scope of the claims. The various features of the disclosure described herein may be implemented in different systems and devices. The components and/or elements may be assembled or otherwise operationally configured in a variety of permutations. As such, the present teachings can be readily applied to other types of apparatuses, networks, configurations, and methods and many alternatives, modifications, and variations will be apparent to those skilled in the art. Therefore, the embodiments are not limited to the particular examples disclosed herein but also include modifications within the scope of the appended claims.

As used herein, the terms “comprise,” “comprises,” “comprising,” “having,” “including,” “includes” or any variation thereof, are intended to reference a nonexclusive inclusion, such that a process, method, article, composition or apparatus that comprises a list of elements does not include only those elements recited, but may also include other elements not expressly listed or inherent to such process, method, article, composition, or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

As may be used herein, the term “operable to” or “configurable to” indicates that an element includes one or more of circuits, instructions, modules, data, input(s), output(s), etc., to perform one or more of the described or necessary corresponding functions and may further include inferred coupling to one or more other items to perform the described or necessary corresponding functions. As may also be used herein, the term(s) “coupled,” “coupled to,” “connected to,” “connecting,” and/or “communicate with” includes direct connection or link between nodes/devices/networks and/or indirect connection between nodes/devices/network via one or more intervening nodes/devices/networks. As may further be used herein, inferred connections (i.e., where one element is connected to another element by inference) includes direct and indirect connection between two items in the same manner as “connected to” described above.

Moreover, reference to an element in the singular is not intended to mean “one and only one” but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims.

Moreover, nothing disclosed herein is intended to be dedicated to the public regardless of whether such disclosure is explicitly recited in the claims. No claim element is intended to be construed under the provisions of 35 U.S.C. § 112(f) as a “means-plus-function” type element, unless the element is expressly recited using the phrase “means for” or, in the case of a method claim, the element is recited using the phrase “step for.”

1. A computer system, comprising:
at least one memory device; and
at least one processing circuit, wherein the processing circuit is operatively coupled to the at least one memory device and wherein the at least one memory device stores instructions that, when executed by the at least one processing circuit, causes the computer system to:
generate a gratitude notification using input data from a user device of a sender, wherein the gratitude notification includes a plurality of data fields, wherein the plurality of data fields includes at least the sender, a recipient, and donation or service data;
obtain a first permission level for the gratitude notification and/or one or more of the plurality of data fields from the user device of the sender;
obtain a second permission level for the gratitude notification and/or the one or more of the plurality of data fields from the recipient;
reconcile the first permission level and the second permission level to determine an associated permission level for the gratitude notification;
determine the associated permission level for the gratitude notification permits posting the gratitude notification to at least one social media account of a social media system of the recipient; and
communicate with the social media system to post the gratitude notification to the at least one social media account of the social media system of the recipient.

2. The computer system of claim 1, wherein the computer system is further caused to:
determine the associated permission level for the gratitude notification prohibits posting a first data field of the plurality of data fields of the gratitude notification to the at least one social media account of the social media system of the recipient; and
communicate with the social media system to post the gratitude notification without the first data field to the at least one social media account of the recipient.

3. The computer system of claim 1, wherein the computer system is further caused to:
store the plurality of data fields of the gratitude notification in a notification database, wherein the notification database is stored on the at least one memory device.

4. The computer system of claim 3, wherein the computer system is further caused to:
generate an interface to access and search the notification database, wherein the notification database includes a plurality of additional gratitude notifications and wherein the interface includes at least the following search fields: a recipient name and a sender name.

5. The computer system of claim 4, wherein the computer system is further caused to:
provide public access to the gratitude notification in the notification database in accordance with the associated permission level.

6. The computer system of claim 5, wherein the computer system is further caused to:
generate another gratitude notification using second data input from a second user device of a second sender wherein the another gratitude notification includes another plurality of data fields, wherein the another plurality of data fields includes at least the second sender, a second recipient, and a second donation or service data;
obtain a third permission level for the another gratitude notification and/or one or more of the another plurality of data fields from the second user device of the second sender;
obtain a fourth permission level for the another gratitude notification and/or the one or more of the another plurality of data fields from the second recipient;
reconcile the third permission level and the fourth permission level to determine an associated permission level for the another gratitude notification;
determine the associated permission level for the another gratitude notification prohibits posting the another gratitude notification to at least one social media account of a social media system of the second recipient; and
store the another gratitude notification in the notification database with restriction for access only by the second sender and by the second recipient.

7. The computer system of claim 1, wherein the computer system is further caused to:
communicate with the user device of the sender to display one or more graphical user interfaces (GUIs) on the user device;
using the one or more GUIs, obtain the input data for the gratitude notification from the user device, wherein the one or more GUIs are configured to include one or more suggestions for completing the data input for the gratitude notification.

8. The computer system of claim 7, wherein the one or more GUIs include the plurality of data fields for the gratitude notification, wherein the plurality of data fields further includes: a service description, a donation description, a date and/or time of a service or a donation, a personal note, and a delivery date and/or time.

9. The computer system of claim 8, wherein the machine learning model is further configured to analyze and recommend default permission levels for future gratitude notifications based on contextual similarity to previously reconciled gratitude notifications, wherein the machine learning model is a supervised learning model trained on labeled training data comprising gratitude notification attributes and reconciled permission outcomes; and
wherein the machine learning model adjusts its reconciliation outputs based on user override actions or feedback signals indicating user satisfaction with prior publication outcomes.

10. The computer system of claim 1, wherein the computer system is further caused to obtain the second permission level for the gratitude notification and/or the one or more of the plurality of data fields from the recipient by:
communicating a message to a recipient device or to the at least one social media account of the social media system of the recipient, wherein the message includes a hyperlink to at least one GUI that displays the gratitude notification and includes at least one data field for obtaining the second permission level for the gratitude notification and/or the one or more of the plurality of data fields from the recipient.

11. The computer system of claim 1, wherein the machine learning model incorporates contextual data including time of day, device type, or geographic location to further refine reconciliation of permission levels.

12. The computing system of claim 1, wherein the second permission level for the gratitude notification from the recipient is obtained from the machine learning model in the absence of explicit input from the recipient, based on historical behavioral data and social graph analysis; and
wherein the computer system is further caused to provide a dashboard interface to review and modify the machine learning model's rationale or prediction.

13. The computer system of claim 1, wherein the computer system is further caused to use a predictive model trained to estimate the likelihood that a recipient will approve public sharing.

14. The computer system of claim 1, wherein the machine learning model allows for user-specific or group-specific training data to tailor predictions to demographic, cultural, or organizational contexts.

15. The computer system of claim 1, wherein the computer system is further caused to:
schedule a future delivery of the gratitude notification; or
associate the future delivery of the gratitude notification with an anniversary or recurring event, wherein the future delivery is stored in a gratitude timeline.

16. The computer system of claim 1, wherein the computer is further caused to reconcile the first permission level and the second permission level to determine the associated permission level for the gratitude notification by:
processing the first and second permission levels using a machine learning model trained to reconcile any conflicts between the first and second permission levels and to determine the associated permission level for the gratitude notification, wherein the machine learning model is trained on data relating to one or more of: historical sender-recipient interactions, gratitude notification metadata, and prior privacy settings.

17. A method of a computer system for generating a gratitude notification, comprising:
generating, by at least one processing unit of the computer system, the gratitude notification using input data from a user device of a sender, wherein the gratitude notification includes a plurality of data fields, wherein the plurality of data fields includes at least the sender, a recipient, and donation or service data;
obtaining, by the at least one processing unit of the computer system, a first permission level for the gratitude notification and/or one or more of the plurality of data fields from the user device of the sender;
obtaining, by the at least one processing unit of the computer system, a second permission level for the gratitude notification and/or the one or more of the plurality of data fields from the recipient;
reconciling, by the at least one processing unit of the computer system, the first permission level and the second permission level to determine an associated permission level for the gratitude notification;
determining, by the at least one processing unit of the computer system, the associated permission level for the gratitude notification permits posting the gratitude notification to at least one social media account of a social media system of the recipient; and
communicating, by the at least one processing unit and a transceiver of the computer system, with the social media system to post the gratitude notification to the at least one social media account of the social media system of the recipient.

18. The method of the computer system of claim 17, further comprising:
determining, by the at least one processing unit of the computer system, that the associated permission level for the gratitude notification prohibits posting a first data field of the plurality of data fields of the gratitude notification to the at least one social media account of the social media system of the recipient; and
communicating, by the at least one processing unit and the transceiver of the computer system, with the social media system to post the gratitude notification without the first data field to the at least one social media account of the recipient.

19. The method of the computer system of claim 17, further comprising:
storing, by the at least one processing unit of the computer system, the plurality of data fields of the gratitude notification in a notification database, wherein the notification database is stored on the at least one memory device.

20. The method of the computer system of claim 19, further comprising:
generating, by the at least one processing unit of the computer system, an interface to access and search the notification database, wherein the notification database includes a plurality of additional gratitude notifications and wherein the interface includes at least the following search fields: a recipient name and a sender name.

21. The method of the computer system of claim 20, further comprising:
permitting, by the at least one processing unit of the computer system, public access to the gratitude notification in the notification database in accordance with the associated permission level.

22. The method of the computer system of claim 21, further comprising:
generating, by the at least one processing unit of the computer system, another gratitude notification using second data input from a second user device of a second sender wherein the another gratitude notification includes another plurality of data fields, wherein the another plurality of data fields includes at least the second sender, a second recipient, and a second donation or service data;
obtaining, by the at least one processing unit of the computer system, a third permission level for the another gratitude notification and/or one or more of the another plurality of data fields from the second user device of the second sender;
obtaining, by the at least one processing unit of the computer system, a fourth permission level for the another gratitude notification and/or the one or more of the another plurality of data fields from the second recipient;
reconciling, by the at least one processing unit of the computer system, the third permission level and the fourth permission level to determine an associated permission level for the another gratitude notification;
determining, by the at least one processing unit of the computer system, the associated permission level for the another gratitude notification prohibits posting the another gratitude notification to at least one social media account of a social media system of the second recipient; and
storing, by the at least one processing unit of the computer system, the another gratitude notification in the notification database with restriction for access only by the second sender and by the second recipient.

23. The method of the computer system of claim 17, further comprising:
communicating, by the at least one processing unit and the transceiver of the computer system, with the user device of the sender to display one or more graphical user interfaces (GUIs) on the user device;
using the one or more GUIs, obtaining, by the at least one processing unit of the computer system, the input data for the gratitude notification from the user device, wherein the one or more GUIs are configured to include one or more suggestions for completing the data input for the gratitude notification.

24. The method of the computer system of claim 23, wherein the one or more GUIs include the plurality of data fields for the gratitude notification, wherein the plurality of data fields further includes: a service description, a donation description, a date and/or time of a service or a donation, a personal note, and a delivery date and/or time.

25. The method of the computer system of claim 24, wherein the one or more GUIs are configured to include an option to transmit an electronic card to the recipient.

26. The method of the computer system of claim 17, wherein obtaining, by the at least one processing unit of the computer system, the second permission level for the gratitude notification and/or the one or more of the plurality of data fields from the recipient includes:
communicating, by the at least one processing unit and the transceiver of the computer system, a message to a recipient device or to the at least one social media account of the social media system of the recipient, wherein the message includes a hyperlink to at least one GUI that displays the gratitude notification and includes at least one data field for obtaining the second permission level for the gratitude notification and/or the one or more of the plurality of data fields from the recipient.

27. The method of the computer system of claim 17, further comprising:
generating, by a natural language processing (NLP) engine, one or more suggested values for one or more of the plurality of data fields of the gratitude notification, based on analysis of unstructured textual input received from the sender.

28. The method of the computer system of claim 27, wherein the unstructured textual input comprises a freeform thank-you message or description of an act of kindness of the recipient; and
wherein the NLP engine classifies the text into one or more thematic categories.

29. The method of claim 28, wherein the one or more suggestions for the one or more suggested values for one or more of the plurality of data fields of the gratitude notification are presented to the sender via a graphical user interface (GUI) with pre-filled fields that the sender can confirm, edit, or override.

30. The method of claim 29, wherein the NLP engine employs a transformer-based language model trained on a corpus of gratitude expressions, donor acknowledgments, and social messages.

31. The method of claim 30, wherein the NLP engine extracts temporal indicators from the unstructured textual input to suggest a delivery date and/or time for the gratitude notification.

32. The method of claim 17, further comprising:
storing the gratitude notification in a version-controlled archive such that each permission level change is timestamped and auditable.

33. The method of claim 17, further comprising:
obtaining feedback data from the recipient or other viewer of the gratitude notification; and
using the feedback to update a training dataset of the machine learning model.

34. The method of claim 17, further comprising:
integrating the gratitude notification with a third-party application, wherein the third party application is at least one of: an email client, a customer relationship management (CRM) system, or fundraising platform.

35. The method of claim 17, further comprising:
classifying a sentiment of the unstructured textual input and applying a matching visual or stylistic theme to the gratitude notification.

36. The method of claim 17, wherein the NLP engine suggests alternate phrasings of unstructured textual input included in the gratitude notification to match a target tone selected by the sender from a list including “formal,” “joyful,” “personal” “casual,” or “professional.”
